(19) United States
(12) Patent Application Publication
(10) Pub. No.: US 2026/0302943 A1
(43) Pub. Date: Oct. 1, 2026

(54) CONTROL DEVICE FOR FUEL CELL SYSTEM AND CONTROL METHOD THEREFOR

(71) Applicant: HONDA MOTOR CO., LTD., TOKYO (JP)

(72) Inventors: Ryoma HAMASUNA, WAKO-SHI (JP); Kentaro SAKASHITA, WAKO-SHI (JP); Shinya ABE, WAKO-SHI (JP)

(21) Appl. No.: 19/631,196

(22) Filed: Mar. 27, 2026

(30) Foreign Application Priority Data
Mar. 31, 2025 (JP) 2025-058380

(51) Int. Cl. H02M 3/156; H01M 8/04858; H01M 8/04992

(52) U.S. Cl. CPC H02M 3/156; H01M 8/0494; H01M 8/04992

(57) ABSTRACT

A control unit of a control device of a fuel cell system preferentially operates a step-up converter centrally disposed in a three-parallel step-up converter, over a step-upconverter and a step-up converter arranged on both sides of the step-upconverter centrally disposed, in accordance with required power for a load.

### CROSS-REFERENCE TO RELATED APPLICATIONS

This application is based upon and claims the benefit of priority from Japanese Patent Application No. 2025-058380 filed on Mar. 31, 2025, the contents of which are incorporated herein by reference.

### BACKGROUND OF THE INVENTION

### Field of the Invention

The present disclosure relates to a control device for a fuel cell system including a fuel cell that generates electric power by an electrochemical reaction of both reactant gases of a fuel gas and an oxygen-containing gas, and a control method therefor.

### Description of the Related Art

In recent years, research and development have been conducted on fuel cells (FC) that contribute to energy efficiency in order to ensure access of more people to affordable, reliable, sustainable and modern energy.

For example, JP 2010-279135 A discloses a control device for a multi-phase converter that determines the number of switching elements to be driven, which are connected in parallel, in accordance with a required electric power (required load) of a load electrically connected to a fuel cell.

JP 2010-279135 A discloses in paragraphs [0055] to [0056] that, when the number of switching elements to be driven is three or more, thermal interference can be suppressed by determining, as the switching elements not to be driven, the switching elements located between the switching elements on both outer sides.

Further, JP 2010-279135 A discloses in paragraph [0053] that, by selecting the drive phase at random and performing switching control, it is possible to prevent, in advance, deterioration of the characteristics of the switching elements that would otherwise result from repeatedly using only particular switching elements.

Further, for example, JP 2009-163948 A discloses a fuel cell system including a three-phase converter.

JP 2009-163948 A discloses in paragraph [0049] that all the converters of the three-phase converter are used at the time of a high load. During low-boost and low-load conditions such as at the time of starting or stopping, only the boost converter (step-up converter) having a wide boost-ratio range in which soft switching is achievable is used. When the load is at a medium level, two boost converters are used. It is disclosed that the switching losses can be reduced by controlling the system in this manner.

### SUMMARY OF THE INVENTION

An object of the present disclosure is to provide a control device for a fuel cell system and a control method thereof that enable further improvement in efficiency (efficiency improvement) of a three-parallel step-up converter.

A control device for a fuel cell system according to one aspect of the present disclosure is a control device for a fuel cell system, the control device including: a fuel cell that generates electric power by using reactant gases supplied thereto; a three-parallel step-up converter that steps up a power generation voltage generated by the fuel cell, the three-parallel step-up converter including three step-up converters electrically connected in parallel; a load to which electric power is supplied from the three-parallel step-up converter; and a control unit that controls the load and operation of the three-parallel step-up converter, wherein the three step-up converters of the three-parallel step-up converter are integrally arranged in parallel on a substrate, between positive and negative input terminals and positive and negative output terminals, and wherein in accordance with a required power for the load, the control unit preferentially operates a step-up converter of a center phase among the three step-up converters, over step-up converters of both side phases among the three step-up converters, the step-up converter of the center phase being centrally disposed among the three step-up converters, the step-up converters of both the side phases being disposed on both sides of the step-up converter of the center phase centrally disposed.

A control method for a fuel cell system according to another aspect of the present disclosure is a control method for a fuel cell system including a fuel cell that generates electric power by using reactant gases supplied thereto and a three-parallel step-up converter that steps up a power generation voltage generated by the fuel cell, the three-parallel step-up converter including three step-up converters electrically connected in parallel, the control method including operating only a step-up converter of a center phase among the three step-up converters in a single-phase operation, and operating the step-up converter of the center phase and one of step-up converters of side phases among the three step-up converters in a two-phase operation.

According to the present disclosure, it is possible to achieve a further improvement (further increase) in the efficiency of the three-parallel step-up converter. This contributes to improved energy efficiency.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic configuration diagram of a fuel cell vehicle in which a fuel cell system including a control device according to an embodiment is incorporated;

FIG. 2 is a circuit diagram of a three-parallel step-up converter module including a three-parallel step-up converter;

FIG. 3 is an actual wiring diagram of a three-parallel step-up converter module including a three-parallel step-up converter;

FIG. 4 is a schematic waveform diagram showing a step response of the step-up converter of the center phase (indicated by a broken line) and a step response of the step-up converters of the both the outer phases (indicated by a solid line);

FIG. 5 is a schematic frequency-response diagram showing a frequency response of the step-up converter of the center phase (indicated by a broken line) and a frequency response of the step-up converters of both the outer phases (indicated by a solid line);

FIG. 6 is a table showing the contents of a step-up converter determination map; and

FIG. 7 is a flowchart used for explaining the operation of the control device according to the embodiment.

### DETAILED DESCRIPTION OF THE INVENTION

### Configuration

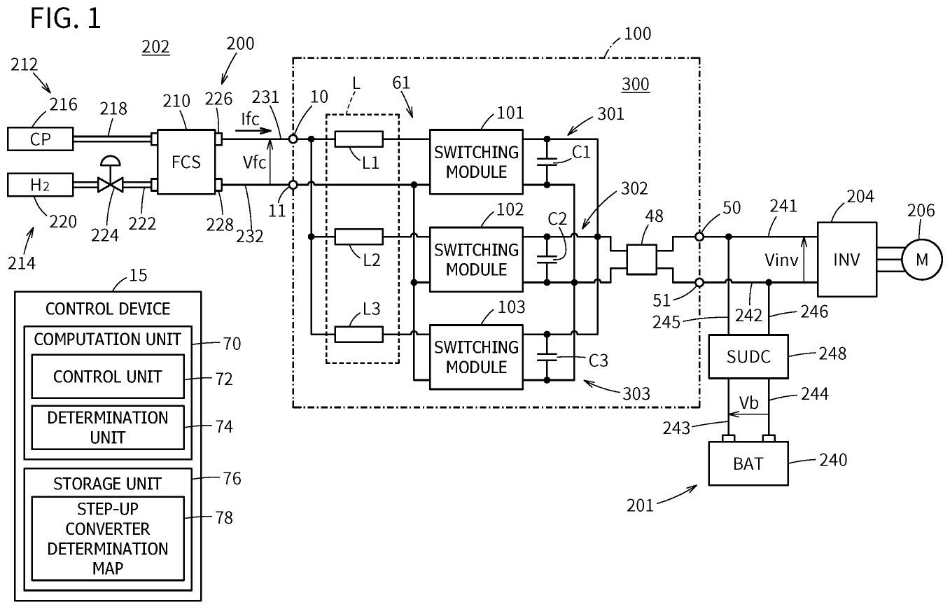

FIG. 1 is a schematic configuration diagram of a fuel cell vehicle 202 in which a fuel cell system 200 including a control device 15 according to an embodiment is incorporated. The control device 15 performs a method for controlling the fuel cell system 200 according to the embodiment.

The fuel cell system 200 can be incorporated not only into the fuel cell vehicle 202 but also into other mobile bodies such as ships, aircrafts, and robots, as well as into buildings such as factory facilities.

The fuel cell vehicle 202 includes a fuel cell system 200, a power storage device system 201, a drive motor (load) 206 driven through an inverter (power conversion device) 204, and a control device 15 that controls the entire fuel cell vehicle 202.

The drive motor 206 is a motor generator, and serves as a load of the fuel cell system 200 during power running and functions as a power generator during regeneration.

The control device 15 may be provided not only as a single control device but also as two or more control devices, for example, a control device for the fuel cell system 200 and a control device for the drive motor 206.

The fuel cell system 200 includes a fuel cell stack (also simply referred to as a fuel cell) 210, an oxygen-containing gas supply device 212, a fuel gas supply device 214, a coolant supply device (not shown), and a power storage device 240.

The oxygen-containing gas supply device 212 includes a compressor (CP) 216 capable of adjusting the impeller rotational speed, and an oxygen-containing gas supply flow path 218. The compressor 216 compresses outside air and supplies the compressed outside air, as oxygen-containing gas, to the fuel cell 210 through the oxygen-containing gas supply flow path 218.

The fuel gas supply device 214 includes a hydrogen tank (fuel gas storage device) 220, a fuel gas supply flow path 222, and a pressure adjusting valve 224 provided in the fuel gas supply flow path 222.

The fuel gas supply device 214 decompresses high-pressure fuel gas (hydrogen) stored in the hydrogen tank 220 via the pressure adjusting valve 224, and supplies the decompressed fuel gas to the fuel cell 210 through the fuel gas supply flow path 222.

The fuel cell 210 generates electric power by electrochemical reaction of both supplied reactant gases (oxygen-containing gas and fuel gas), thereby generating a power generation voltage Vfc between a positive output terminal 226 and a negative output terminal 228, and supplying a power generation current Ifc from the positive output terminal 226 and the negative output terminal 228 to outside. The generated power Pfc of the fuel cell 210 is calculated by multiplying the power generation voltage Vfc by the power generation current Ifc.

The fuel cell system 200 includes a three-parallel step-up (boost) converter module (also simply referred to as a step-up module) 100, which is mounted on an aluminum plate having good heat dissipation, with the module being electrically insulated from the plate.

The step-up module 100 shown within the one-dot chain line frame includes an input terminal (positive input terminal) 10, an input terminal (negative input terminal) 11, an output terminal (positive output terminal) 50, and an output terminal (negative output terminal) 51. The negative input terminal 11 and the negative output terminal 51 may be regarded, electrically, as serving the function of ground terminals.

The step-up module 100 includes an inductor (common-mode coil) L including inductors L1, L2, and L3, switching modules 101 to 103, smoothing capacitors C1 to C3, and a ring-shaped ferrite core 48.

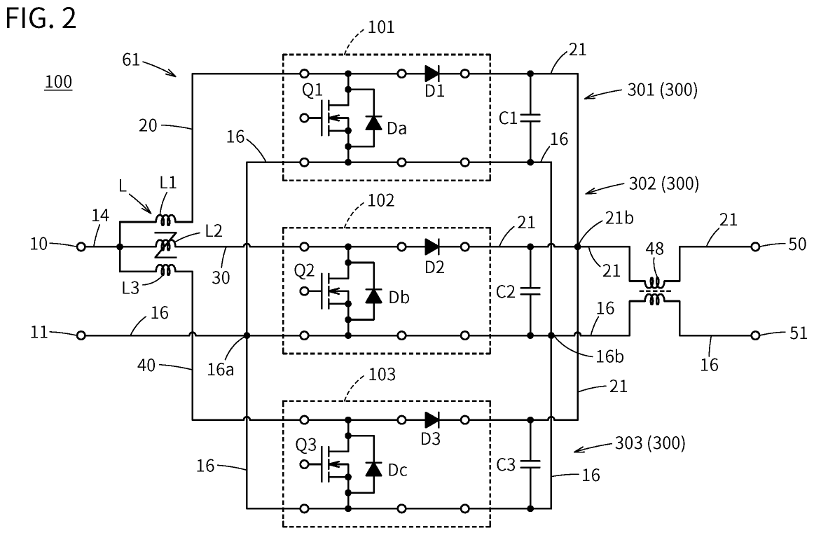

FIG. 2 shows a circuit diagram of a three-parallel step-up converter module 100 comprising a three-parallel step-up converter 300.

As shown in FIG. 2, the switching modules 101, 102, and 103 respectively include: switching elements Q1, Q2, and Q3 each having a reverse diode Da, Db, and Dc connected in parallel thereto; and diodes (rectifier diodes) D1, D2, and D3.

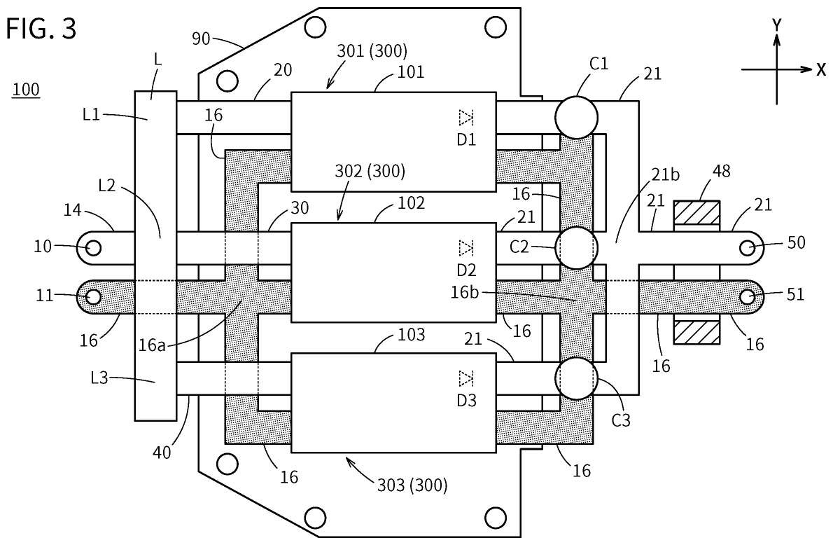

FIG. 3 is an actual wiring diagram of the three-parallel step-up converter module 100 including the three-parallel step-up converter 300. As shown in FIG. 3, the three-parallel step-up converter 300 is disposed on a substrate 90 made of an aluminum flat plate, and integrally attached to the substrate 90. That is, three step-up converters included in the three-parallel step-up converter 300 are integrally disposed in parallel on the substrate 90, between the positive and negative input terminals 10 and 11, and the positive and negative output terminals 50 and 51.

As shown in FIG. 1, the positive input terminal 10 is connected to a positive output terminal 226 of the fuel cell 210 through a positive bus bar (positive bus) 231. The negative input terminal 11 is connected to a negative output terminal 228 of the fuel cell 210 through a negative bus bar (negative bus) 232.

The positive bus bar 231 and the negative bus bar 232 are each formed of a thick copper plate (bus bar). The positive bus bar 231 and the negative bus bar 232 may alternatively be formed of thick electric wires (copper wires). In the present disclosure, the electric wire and the bus bar are basically interchangeable.

The positive output terminal 50 of the three-parallel step-up converter module 100 shown in FIG. 3 is connected to the positive terminal of the inverter 204 through an electric wire (bus bar) 241 (FIG. 1). The negative output terminal 51 of the three-parallel step-up converter module 100 is connected to the negative terminal of the inverter 204 through an electric wire (bus bar) 242 (FIG. 1).

As shown in FIG. 3, the three-parallel step-up converter module 100 includes the three-parallel step-up converter (SUC) 300. The three-parallel step-up converter 300 includes a center-phase step-up converter (step-up converter of a center phase) 302 disposed at the center (i.e., centrally disposed) and outer-phase step-up converters 301 and 303 (step-up converters of side phases) disposed on both outer sides of the center-phase step-up converter 302.

The three-parallel step-up converter 300 boosts (steps up) the power generation voltage Vfc (FIG. 1) applied between the positive input terminal 10 and the negative input terminal 11, and applies the boosted voltage between the positive output terminal 50 and the negative output terminal 51.

As shown in FIG. 1, the boosted voltage of the power generation voltage Vfc is applied, as the direct-current (DC) terminal voltage Vinv, to the DC input terminals of the inverter 204 from the three-parallel step-up converter module 100.

The fuel cell system 200 further includes a power storage device 240 such as a lithium ion secondary battery. The power storage device 240 generates a storage voltage Vb between its positive terminal and negative terminal.

The positive terminal of the power storage device 240 is connected to the low-voltage positive terminal of the step-up/step-down converter (SUDC) 248 through an electric wire (bus bar) 243. The negative terminal of the power storage device 240 is connected to the low-voltage negative terminal of the step-up/step-down converter 248 through an electric wire (bus bar) 244.

The high-voltage positive terminal of the step-up/step-down converter 248 is connected to the electric wire 241 through an electric wire (bus bar) 245. The high-voltage negative terminal of the step-up/step-down converter 248 is connected to the electric wire 242 through an electric wire (bus bar) 246.

During power-running of the drive motor 206, the step-up/step-down converter 248 steps up the storage voltage Vb of the power storage device 240 and applies, as the DC terminal voltage Vinv, the stepped-up voltage to the DC terminals of the inverter 204.

The DC terminal voltage Vinv is converted into a three-phase alternating current (AC) voltage by the inverter 204 and drives the drive motor 206. As a result, the fuel cell vehicle 202 travels.

On the other hand, during regeneration such as downhill traveling, the three-phase AC voltage generated in the drive motor 206 is converted into a DC terminal voltage (DC link voltage) Vinv by the inverter 204. The DC terminal voltage Vinv is stepped down to the storage voltage Vb by the step-up/step-down converter 248 and applied to the power storage device 240 to charge the power storage device 240.

The power generation voltage Vfc constituting the surplus generated power Pfc of the fuel cell 210 is stepped-up (boosted) by the three-parallel step-up converter 300. The stepped-up voltage is stepped down to the storage voltage Vb by the step-up/step-down converter 248 and applied to the power storage device 240 to charge the power storage device 240.

As shown in FIGS. 2 and 3, the step-up converters 301 to 303 connected in parallel include, between the positive and negative input terminals 10, 11 and the positive and negative output terminals 50, 51, in order from the positive and negative input terminals 10, 11 side, an inductor L (inductors L1, L2, L3), which is a choke coil and a common-mode coil, three parallel switching modules 101, 102, 103, smoothing capacitors C1, C2, C3, and a ferrite core 48. A positive bus bar (positive-side output wiring) 21 and a negative bus bar (negative-side output wiring) 16 extend through the ferrite core 48. The inductor L is configured such that a thick electric wire is wound around a ring core.

As shown in FIG. 2, the three parallel switching modules 101 to 103 are provided with switching elements Q1, Q2, and Q3 between the positive and negative bus bars (20 and 16, 30 and 16, and 40 and 16), respectively. The switching elements Q1, Q2, and Q3 are connected in parallel with the reverse diodes Da, Db, and Dc, respectively. Anode terminals of the output diodes D1, D2, and D3 are connected to the positive bus bars 20, 30, and 40, respectively. The cathode terminals of the output diodes D1, D2, D3 are connected to a common positive busbar 21. The smoothing capacitors C1, C2, and C3 are connected between the positive bus bar 21 and the negative bus bar 16.

The smoothing capacitors C1, C2, and C3 may each be divided into two smoothing capacitors, resulting in a total of six smoothing capacitors. The smoothing capacitors C1, C2, and C3 have the same capacitance, however only one smoothing capacitor C2 having a capacitance three times as large may be provided instead. As will be described later, the capacitance of the smoothing capacitor C2 of the center phase, which is most frequently operated, may be set to a value larger than the capacitances of the smoothing capacitors C1 and C3 of the outer phases on both sides.

In FIG. 3, numerous dots are drawn on the negative bus bar 16, which is a single member manufactured by integral molding, for the sake of convenience of understanding.

As shown in FIGS. 2 and 3, the positive input terminal 10 is provided at one end of the common positive bus bar 14, the other end of the positive bus bar 14 is connected to one end of the inductor L (L1, L2, L3), and the other end of the inductor L (L1, L2, L3) is connected to one end of the positive bus bars 20, 30, 40.

The other ends of the positive bus bars 20, 30, and 40 extend in the X direction in FIG. 3, support the switching modules 101 to 103, further extend in the X direction, and are connected to the anode terminals of the output diodes D1 to D3 within the switching modules 101 to 103, respectively.

The cathode terminal of the output diode D1 is connected to one end of the positive bus bar 21 extending in the X direction. The positive bus bar 21 connected to the cathode terminal of the output diode D1 and extending in the X direction is bent 90 degrees, extends in the-Y direction, and merges at a merging portion (connecting portion) 21b.

The positive bus bar 21, one end of which is connected to the cathode terminal of the output diode D2, extends in the X direction and merges at the merging portion 21b.

The cathode terminal of the output diode D3 is connected to one end of the positive bus bar 21 extending in the X direction. The positive bus bar 21 connected to the cathode terminal of the output diode D3 and extending in the X direction is bent 90 degrees, extends in the Y direction, and merges at the merging portion (connecting portion) 21b.

The positive bus bar 21 extends from the merging portion (connecting portion) 21b in the X direction, and is connected to the positive output terminal 50 through the ferrite core 48.

Therefore, the length of the positive bus bar 21 of the step-up converter 302 of the center phase is shorter than the lengths of the positive bus bars 21 of the step-up converters 301 and 303 of the outer phases located on both sides and having the bent portions, resulting in a reduction of stray inductance.

The negative input terminal 11 is connected to the negative bus bar 16. The negative bus bar 16 extends in the X-direction, and, via a merging (connecting) portion 16a, further extends in the X-direction to serve as the negative bus bar 16 of the switching module 102 of the center phase. This negative bus bar 16 further extends in the X-direction to a merging (connecting) portion 16b, and further extends from the merging (connecting) portion 16b in the X-direction to the negative output terminal 51.

The negative bus bar 16 bends by 90 degrees in the positive-Y-direction and the negative-Y-direction at the merging (connecting) portion 16a to bifurcate into two portions. Then, the two portions extend in those directions, and then bend by 90 degrees in the X-direction to extend in the X-direction. The two portions carry the respective switching modules 101 and 103 located on both sides, serving as the respective negative bus bars 16. The two portions further extend in the X-direction, bend again by 90 degrees in the negative-Y-direction and the positive-Y-direction, and merge at the merging (connecting) portion 16b. The merged negative bus bar 16 further extends from the merging portion (connecting portion) 16b in the X direction, and is connected to the negative output terminal 51 through the ferrite core 48.

The length of the negative bus bar 16 extending from the negative input terminal 11, passing under the central switching module 102, passing through the merging (connecting) portion 16b, and reaching the negative output terminal 51 is shorter than the lengths of the negative bus bars 16 that extend from the negative input terminal 11, bend, pass under the switching modules 101 and 103 on both sides, further bend, reach the merging (connecting) portion 16b, and then reach the negative output terminal 51, and thus the stray inductance of the central negative bus bar is reduced.

The switching modules 101 to 103, the negative bus bar 16, and the positive bus bars 20, 30, 40, and 21 are fixed on the substrate 90 by insert molding. The substrate 90 is made of aluminum die-cast material.

### Transient Response of Step-Up Converter

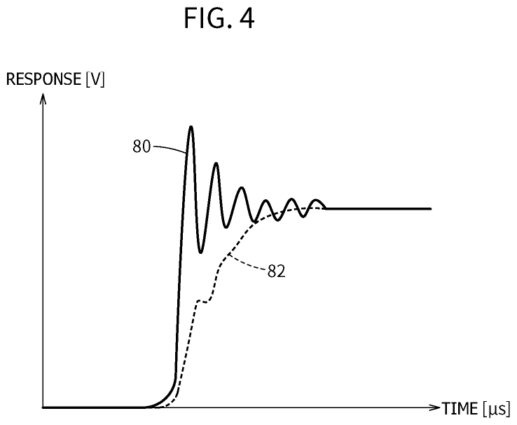

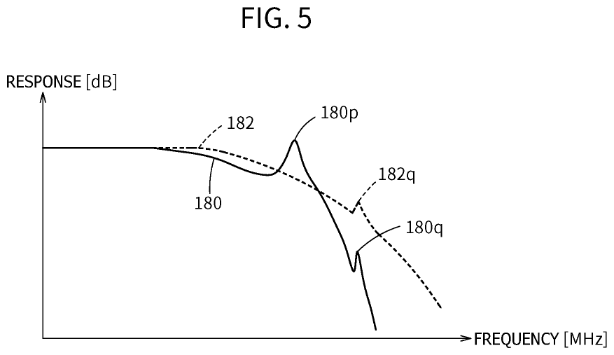

Here, transient responses of the step-up converters 301 to 303 will be described with reference to FIGS. 4 and 5.

FIG. 4 is a schematic waveform diagram showing a step response (transient response) of the step-up converters 301 to 303 connected in parallel. The step response waveform 82 (indicated by the broken line) of the step-up converter 302 of the center phase exhibits a waveform having a smooth rising edge and less distortion than the step response waveform 80 (indicated by the solid line) of the step-up converters 301 and 303 of the phases on both sides.

The step response waveform 82 has a smaller surge voltage than the step response waveform 80, and therefore, efficiency can be improved. The step response waveform 80 indicated by the solid line exhibits ringing at the rising edge, and is a distorted waveform.

It is presumed that the difference between the step response waveform 80 and the step response waveform 82 is mainly attributable to the magnitude of the stray inductance. The step response waveform 80 of the step-up converters 301 and 303, which have longer wiring lengths and larger stray inductances, exhibits greater ringing than that of the step-up converter 302, which has a smaller stray inductance.

FIG. 5 is a schematic frequency-response diagram illustrating frequency response of the step-up converters 301 to 303. A frequency response 182, indicated by a broken line, of the step-up converter 302 of the center phase exhibits a characteristic in which it decreases more gradually with increasing frequency, compared to a frequency response 180, indicated by a solid line, of the step-up converters 301 and 303 of the phases on both sides. The horizontal axis is a logarithmic axis.

The singular point 180p of the frequency response corresponds to the fundamental frequency of the ringing. The singular points 180q and 182q on the high-frequency side in the frequency responses correspond to frequencies that are integer multiples of the ringing frequency. It has been confirmed that the singular points 180q and 182q on the high-frequency side can be reduced by inserting the ferrite core 48.

It has been confirmed that the step-up converter 302 of the center phase, which exhibits smooth step and frequency responses, also generates lower electromagnetic compatibility (EMC) noise. The switching loss of the step-up converter 302 of the center phase is smaller than the switching losses of the step-up converters 301 and 303 of the outer phases on both sides.

The inventors of the present application have found that the following phenomena occur in techniques related to fuel cell systems using the three-parallel step-up converter.

First, the transient response of the three-parallel step-up converter arranged on the substrate differs due to differences in the signal wiring and ground wiring of the step-up converters of the three-parallel step-up converter, that is, differences in stray inductance.

Second, in the three-parallel step-up converter, a difference (superiority or inferiority) in the transient responses of the three step-up converters results in different power losses of the respective converters.

Third, due to the difference in those transient responses, the three-parallel step-up converter exhibits different electromagnetic interference (EMI) characteristics. The present disclosure provides an excellent technique that takes into consideration the above-described phenomena.

### Control Device

Next, the control device 15 will be described. The control device 15 is a computer provided in the fuel cell system 200.

As shown in FIG. 1, the control device 15 includes a computation unit 70 and a storage unit 76. The control device 15 further includes a peripheral device, a display unit, and an operation unit (not illustrated).

The computation unit 70 may be configured by a processor such as a CPU (central processing unit) or a GPU (graphics processing unit), for example. That is, the computation unit 70 may be configured by a processing circuit. The computation unit 70 includes a determination unit 74 and a control unit 72. The determination unit 74 and the control unit 72 can be realized by the computation unit 70 executing a program recorded in the storage unit 76.

At least a part of the determination unit 74 and the control unit 72 may be realized by an integrated circuit such as an ASIC (application specific integrated circuit) or an FPGA (field-programmable gate array). At least a part of the determination unit 74 and the control unit 72 may be configured by an electronic circuit including a discrete device.

The storage unit 76 may be constituted by a volatile memory and a non-volatile memory. Examples of the volatile memory may include a random access memory (RAM). The volatile memory is used as a working memory of the processor, and temporarily stores data and the like necessary for processing or calculation. Examples of the non-volatile memory include a read only memory (ROM) and a flash memory. The non-volatile memory is used as a storage memory to store programs, tables, maps and the like. At least a part of the storage unit 76 may be included in the processor, the integrated circuit, or the like as described above. In this embodiment, a step-up converter determination map 78 is stored in the storage unit 76.

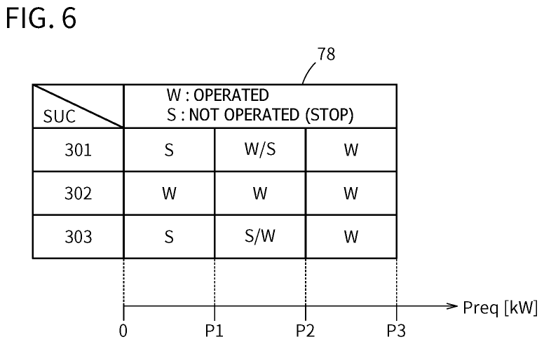

FIG. 6 is a table showing the contents of the step-up converter determination map 78. The step-up converter determination map 78 determines that the step-up converter 302 of the center phase is to be operated, when the load required power Preq(a required power for the load) is equal to or less than the first power threshold P1 (Preq≤P1).

When the load required power Preq is larger than the first power threshold P1 (Preq>P1) and equal to or less than the second power threshold P2 (Preq≤P2), the map determines that the step-up converter 302 of the center phase is to be operated and that one of the step-up converters 301 and 303 of the outer phases on both sides is to be operated. Which of the step-up converters 301 and 303 is to be operated is determined such that their cumulative operation times become substantially equal to each other.

When the load required power Preq is larger than the second power threshold P2 (Preq>P2) and equal to or lower than the third power threshold P3 (Preq≤P3), the map determines that all the step-up converters 301, 302, 303 of the three phases are to be operated.

### Operation

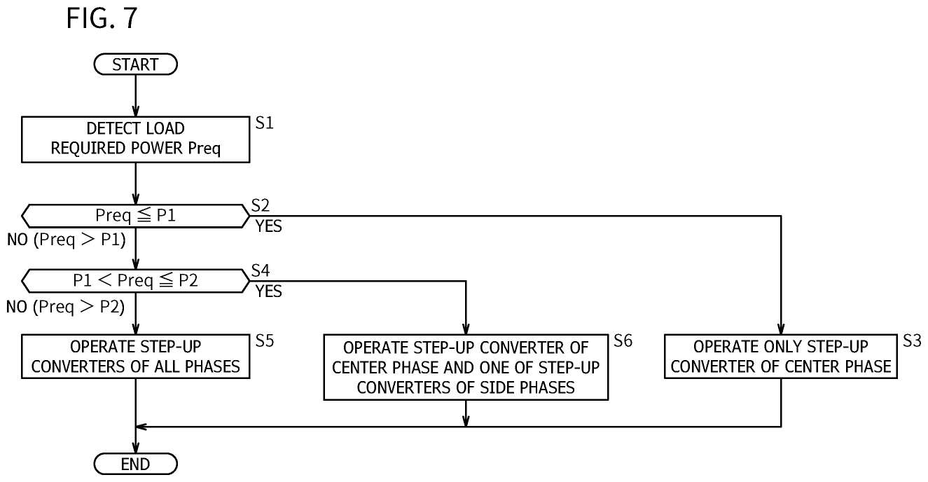

Next, the operation of the control device 15 of the fuel cell system 200 basically configured as described above and the procedure of the control method thereof will be described in detail based on the flowchart shown in FIG. 7.

In step S1, the control unit 72 detects the load required power Preq, and advances the process to step S2. The load required power Preq is the total power consumption of the power-running power to the drive motor 206 (main device) in accordance with the operation amount of the accelerator pedal and the auxiliary-device power required for the auxiliary devices such as the compressor 216. This total power consumption is supplied by the generated power Pfc of the fuel cell 210 and the stored power Pb at of the power storage device 240. The manner in which this supply is distributed between the fuel cell and the power storage device is determined based on the load required power Preq and the state of charge (SOC or remaining battery level) of the power storage device 240.

In step S2, the determination unit 74 determines whether the load required power Preq is equal to or less than the first power threshold P1 or not. In a case where the determination is affirmative (S2: YES), the control unit 72 advances the process to step S3.

In step S3, the control unit 72 operates only the step-up converter 302 of the center phase and ends the current process. In the processing of step S3, the control unit 72 stops the operation of the switching elements Q1 and Q3 of the step-up converters 301 and 303 on both sides and holds the switching elements Q1 and Q3 in the OFF state. In this case, the control unit 72 determines the DC terminal voltage Vinv in accordance with the load required power Preq, determines the duty of the step-up converter 302, and operates the switching module 102. When the SOC has a sufficient margin, the switching element of the step-up/step-down converter 248 is also operated.

As described above, when the load required power Preq is equal to or less than the first power threshold P1, only the step-up converter 302 of the center phase among the step-up converters 301 to 303 connected in parallel is operated, so that the fuel cell system 200 can be operated with improved power conversion efficiency and reduced EMC.

When the determination in step S2 is negative (S2: NO) (Preq>P1), the determination unit 74 further determines, in step S4, whether the load required power Preq is equal to or less than the second power threshold P2 or not.

In a case where the determination in step S4 is negative (S4: NO) (Preq>P2), the control unit 72 advances the process to step S5.

In step S5, the control unit 72 operates all the step-up converters 301 to 303 (i.e., of all phases) connected in parallel, and also operates the step-up/step-down converter 248 as necessary, thereby driving the drive motor 206.

In a case where the determination in step S4 is affirmative (S4: YES) (P1<Preq≤P2), the control unit 72 advances the process to step S6.

In step S6, the control unit 72 operates the step-up converter 302 of the center phase and also operates one of the step-up converters 301 and 303 of the phases on both sides.

Accordingly, in the above-described two phase operation, ringing of transient response is reduced as compared with the case where step-up converters 301 and 303 of the phases on both sides are operated as the two step-up converters. As a result, electromagnetic interference is reduced and the EMI characteristics are improved. At the same time, since the power loss caused by ringing can be reduced, operation with excellent power conversion efficiency can be achieved.

According to the above-described embodiment, among the step-up converters 301 to 303 connected in parallel, the step-up converter 302 of the center phase, which is disposed at the center, has high switching efficiency because ringing is suppressed. By preferentially operating this step-up converter 302 of the center phase, the switching efficiency of the step-up converters 301 to 303 connected in parallel can be improved over a wide range from the low-output region to the high-output region.

Further, the ringing frequency of the step-up converter 302 of the center phase disposed at the center is shifted relative to the ringing frequencies of the step-up converters 301 and 303 of the outer phases disposed on both sides. Therefore, the ringing of the transient response is reduced by preferentially operating the step-up converter 302 of the center phase disposed at the center. This improves the EMI characteristics. At the same time, since the power loss caused by ringing can be reduced, operation with excellent power conversion efficiency can be achieved.

### Modifications

The above-described embodiment can be modified as follows.

### <Modifications>

In the above-described embodiment, in plan view, among the step-up converters 301 to 303 arranged in parallel, the step-up converter 302 of the center phase having a small stray inductance is preferentially operated.

However, in a case where, due to the mounting configuration, the stray inductance of one of the step-up converters disposed on the side phases is configured to be smaller than the stray inductances of the step-up converter on the other side phase and the step-up converter of the center phase, then the one of the step-up converters of the side phases having the smaller stray inductance may be preferentially operated.

### Supplementary Notes

In relation to the above-described disclosure, the following Supplementary Notes are further disclosed.

### Supplementary Note 1

The control device (15) of the fuel cell system (200) of the present disclosure includes: the fuel cell (210) that generates electric power by using reactant gases supplied thereto; the three-parallel step-up (boost) converter (300 (301 to 303)) that steps up a power generation voltage (Vfc) of the fuel cell, the three-parallel step-up converter including three step-up converters electrically connected in parallel; the load (206) to which electric power is supplied from the three-parallel step-up converter; and the control unit (72) that controls the load and operation of the three-parallel step-up converter, wherein the three step-up converters of the three-parallel step-up converter are integrally arranged in parallel on the substrate (90), between the positive and negative input terminals (10, 11) and the positive and negative output terminals (50, 51), and in accordance with the required power for the load, the control unit preferentially operate the step-up converter (302) that is centrally disposed among the three step-up converters, over the step-up converters (301, 303) disposed on both sides of the step-up converter centrally disposed among the three step-up converters.

According to such a configuration, it is possible to achieve a further improvement (further increase) in the efficiency of the three-parallel step-up converter. This contributes to improved energy efficiency. More specifically, the step-up converter disposed at the center exhibits high switching efficiency. By preferentially operating the step-upconverter arranged at the center, the switching efficiency of the three-parallel step-up converter can be enhanced. Further, the ringing frequency of the step-up converter disposed at the center is shifted relative to the ringing frequencies of the step-up converters disposed on both sides thereof. Therefore, the ringing of the transient response is reduced by preferentially operating the step-up converter disposed at the center. This improves the EMI characteristics. At the same time, since power loss caused by ringing can be reduced, operation with excellent power conversion efficiency can be achieved.

### Supplementary Note 2

In the control device for the fuel cell system according to Supplementary Note 1, in the case where the step-up converter of the center phase is preferentially operated over the step-up converters of both the side phases, the control unit may be configured to, in the single-phase operation, operate only the step-up converter of the center phase, and in the two-phase operation, operate the step-up converter of the center phase and one of the step-up converters of both the side phases. According to this, since ringing of transient response is reduced in the single-phase operation and two-phase operation, it is possible to reduce electromagnetic interference and the like and improve EMI characteristics. At the same time, since power loss caused by ringing can be reduced, operation with excellent power conversion efficiency can be achieved.

### Supplementary Note 3

In the control device for the fuel cell system according to Supplementary Note 1, the control unit may operate only the step-up converter of the center phase, then operate the step-up converter of the center phase and one of the step-up converters of both the side phases, and then operate all the step-up converters of the three phases, in this order, as the magnitude of the required power for the load increases. According to this, by operating an optimal number of step-up converters in accordance with the required power for the load, the average system efficiency of the fuel cell system can be improved.

### Supplementary Note 4

In the control device for the fuel cell system according to Supplementary Note 1, each of the step-up converters electrically connected in parallel may include the output diode (D1, D2, D3), and the connection distance from the cathode terminal of the output diode (D2) of the center phase to the positive output terminal (50) of the positive and negative output terminals may be shorter than the connection distance from the cathode terminal of each of the output diodes (D1, D3) of both the side phases to the positive output terminal. According to this configuration, since the connection distance from the output diode of the center phase to the positive output terminal becomes the shortest, the stray inductance proportional to the connection distance is minimized, and the ringing in the transient response of the step-up converter of the center phase can be made smaller than the ringing of the step-up converters of the side phases.

### Supplementary Note 5

In the control device for the fuel cell system according to Supplementary Note 4, the three-parallel step-up converter may include the smoothing capacitor (C1, C2, C3), and the smoothing capacitor may be composed of at least three smoothing capacitors. According to this, the output currents of the three phase step-up converters can charge the respective capacitors through the shortest possible connection path, and thus ringing can be further reduced.

### Supplementary Note 6

The control device for the fuel cell system according to Supplementary Note 4 may include the ferrite core (48) through which the positive-side output wiring (21) and the negative-side output wiring (16) extend, wherein the positive-side output wiring includes one end connected to the cathode terminal of the output diode and the other end connected to the positive output terminal, and the negative-side output wiring includes one end connected to the negative input terminal of the positive and negative input terminals and the other end connected to the negative output terminal of the positive and negative output terminals. According to this configuration, it is possible to further suppress high-frequency ringing due to the high-frequency loss of the ferrite core.

### Supplementary Note 7

The control method for the fuel cell system is the control method for the fuel cell system including the fuel cell generating electric power by using reactant gases supplied thereto and the three-parallel step-up converter boosting the power generation voltage generated by the fuel cell, the control method including operating only the step-up converter of the center phase in the single-phase operation, and operating the step-up converter of the center phase and one of the step-up converters of the side phases in the two-phase operation.

According to such a configuration, it is possible to achieve a further improvement (further increase) in the efficiency of the three-parallel step-up converter. This contributes to improved energy efficiency. According to this, since ringing of transient response is reduced in the single-phase operation and two-phase operation, it is possible to reduce electromagnetic interference and the like and improve EMI characteristics. At the same time, since power loss caused by ringing can be reduced, operation with excellent power conversion efficiency can be achieved.

The present disclosure is not necessarily limited to each of the embodiments described above. In these embodiments, various additions, replacement, changing, partial deletion, and the like can be made without departing from the essence and gist of the present disclosure or without departing from the essence and gist of the present disclosure derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same applies also in the case that numerical values or mathematical equations are used in the description of the aforementioned embodiments.

1. A control device for a fuel cell system, comprising:
a fuel cell configured to generate electric power by using reactant gases supplied thereto;
a three-parallel step-up converter configured to step up a power generation voltage generated by the fuel cell, the three-parallel step-up converter including three step-up converters electrically connected in parallel;
a load to which electric power is supplied from the three-parallel step-up converter;
a control unit configured to control the load and operation of the three-parallel step-up converter; and
one or more processors configured to execute computer-executable instructions stored in a memory,
wherein the three step-up converters of the three-parallel step-up converter are integrally arranged in parallel on a substrate, between positive and negative input terminals and positive and negative output terminals, and
the one or more processors execute the computer-executable instructions to cause the control device for the fuel cell system to:
in accordance with a required power for the load, preferentially operate a step-up converter of a center phase among the three step-up converters, over step-up converters of both side phases among the three step-up converters, the step-up converter of the center phase being centrally disposed among the three step-up converters, the step-up converters of both the side phases being disposed on both sides of the step-up converter of the center phase.

2. The control device for the fuel cell system according to claim 1, wherein
the one or more processors cause the control device for the fuel cell system to:
in a case where the step-up converter of the center phase is preferentially operated over the step-up converters of both the side phases,
in a single-phase operation, operate only the step-up converter of the center phase, and in a two-phase operation, operate the step-up converter of the center phase and one of the step-up converters of both the side phases.

3. The control device for the fuel cell system according to claim 1, wherein
the one or more processors cause the control device for the fuel cell system to:
operate only the step-up converter of the center phase, then operate the step-up converter of the center phase and one of the step-up converters of both the side phases, and then operate all the step-up converters of three phases, in this order, as a magnitude of the required power for the load increases.

4. The control device for the fuel cell system according to claim 1, wherein
each of the step-up converters electrically connected in parallel includes an output diode, and a connection distance from a cathode terminal of the output diode of the center phase to a positive output terminal of the positive and negative output terminals is shorter than a connection distance from a cathode terminal of each of the output diodes of both the side phases to the positive output terminal.

5. The control device for the fuel cell system according to claim 4, wherein
the three-parallel step-up converter includes a smoothing capacitor, and the smoothing capacitor comprises at least three smoothing capacitors.

6. The control device for the fuel cell system according to claim 4, further comprising
a ferrite core through which a positive-side output wiring and a negative-side output wiring extend, wherein the positive-side output wiring includes one end connected to the cathode terminal of the output diode and another end connected to the positive output terminal, and the negative-side output wiring includes one end connected to a negative input terminal of the positive and negative input terminals and another end connected to a negative output terminal of the positive and negative output terminals.

7. A control method for a fuel cell system, wherein the fuel cell system includes:
a fuel cell configured to generate electric power by using reactant gases supplied thereto; and
a three-parallel step-up converter configured to step up a power generation voltage generated by the fuel cell, the three-parallel step-up converter including a step-up converter of a center phase and step-up converters of both side phases disposed on both sides of the step-up converter of the center phase, the control method comprising:
operating only the step-up converter of the center phase in a single-phase operation in which one step-up converter of the three-parallel step-up converter is operated; and
operating one of the step-up converters of both the side phases in addition to the step-up converter of the center phase in a two-phase operation in which two step-upconverters of the three-parallel step-up converter are operated.

8. The control method for the fuel cell system according to claim 7, wherein
when a load is driven by the three-parallel step-up converter, in the two-phase operation, a required power for the load is set to be larger than in the single-phase operation.
